(19) United States
(12) Patent Application Publication
(10) Pub. No.: US 2011/0059351 A1
(43) Pub. Date: Mar. 10, 2011

(54) LITHIUM ION SECONDARY BATTERY

(75) Inventors: Kazushige Kohno, Hitachi (JP); Tatsuya Toyama, Hitachi (JP); Eiji Seki, Hitachi (JP)

(73) Assignee: Hitachi, Ltd.

(21) Appl. No.: 12/858,459

(22) Filed: Aug. 18, 2010

(30) Foreign Application Priority Data
Sep. 4, 2009 (JP) 2009-204538

(51) Int. Cl. H01M 2/02

(52) U.S. Cl. 429/163

(57) ABSTRACT

A lithium ion secondary battery comprising a positive electrode plate containing a positive electrode active material, a negative electrode plate containing a negative electrode active material, a separator, an electrolyte, and a battery can for enclosing these, wherein the positive electrode active material comprises manganese spinel and a layer-type lithium manganese oxide, and the electrolyte comprises vinylene carbonate and unsaturated sultone.

### BACKGROUND OF THE INVENTION

The present invention relates to a lithium ion secondary battery.

As a power source for electronic devices, a lithium ion secondary battery is expected as a secondary battery expected to allow compact-sizing and weight-reduction. As a positive electrode active material of the lithium ion secondary batteries, a metal oxide containing Li such as lithium cobaltate (LiCoO₂) and lithium manganate (LiMn₂O₄) has been studied and practically used.

However, in recent years, with increasing demand to attain a lower cost battery, technological development for extending life using cheap materials has been required.

To attain this, as the positive electrode material, lithium manganate (LiMn₂O₄) has attracted attention, because of having characteristics of being abundant as a resource and being cheap, as well as being thermally stable even when abused such as over-charging.

However, the lithium manganate generates a decrease in capacity or an increase in resistance accompanied with charge-discharge cycles, due to a problem of Mn elution or the like caused by HF or the like present in an electrolyte, which thus caused a problem relating to its lifetime characteristics.

To improve the charge-discharge characteristics of the lithium manganate, various studies have been made.

JP-A-2003-36846 and JP-A-2007-165111 have proposed a method for mixing layer-type lithium manganese oxide to the lithium manganate.

That is, JP-A-2003-36846 has disclosed a lithium ion secondary battery, having a lithium-manganese composite oxide as a main body of the positive electrode active material, wherein the aforesaid lithium-manganese composite oxide contains two or more kinds of lithium-manganese composite oxides with different crystal structures, and a reversible capacity of the aforesaid positive electrode is equal to or lower than that of a negative electrode. There is described that, according to this lithium ion secondary battery, load on the negative electrode in charging can be reduced and deterioration of the negative electrode can be suppressed.

In addition, JP-A-2007-165111 has disclosed a non-aqueous-type secondary battery having an electrode group, in which a positive electrode sheet and a negative electrode sheet are formed via a separator and a non-aqueous electrolyte, a laminate-like outer package case for storing the aforesaid electrode group, a positive electrode lead and a negative electrode lead connected to the aforesaid positive electrode sheet and the negative electrode sheet respectively, wherein the positive electrode active material used as the positive electrode formed at the aforesaid positive sheet contains a spinel-type lithium manganese oxide and a layer-type lithium manganese oxide, and the aforesaid non-aqueous-type electrolyte has a lithium compound (excluding LiBF₄) containing boron in a non-aqueous-type solution dissolved with a lithium salt in a carbonate-type non-aqueous-type solvent. There is described that this non-aqueous-type secondary battery is capable of increasing an output retention rate in pulse charge-discharges by adding the lithium compound containing boron.

JP-A-2002-329528 has disclosed a non-aqueous electrolyte containing unsaturated sultone. There is described that gas generation or self-discharging in the storage of the non-aqueous electrolyte secondary battery at high temperature can be suppressed, by using this non-aqueous electrolyte.

JP-A-2009-104838 has disclosed a non-aqueous electrolyte secondary battery, providing a positive electrode having a lithium-containing composite oxide with a layer-like structure as an active material, a negative electrode, a separator and a non-aqueous electrolyte, and a positive electrode potential in full charge of equal to or higher than 4.35 V (V vs. Li/Li⁺) Li, wherein the aforesaid non-aqueous electrolyte contains vinyl ethylene carbonate or a derivative thereof, and a predetermined cyclic sulfate ester derivative or a predetermined cyclic sulfuric acid ester derivative.

JP-A-2008-235146 has disclosed a non-aqueous electrolyte secondary battery provided with a positive electrode using a positive electrode active material composed of a lithium-containing metal composite oxide having a layer structure, a negative electrode, and a non-aqueous electrolyte, in which an electrolyte is dissolved in a non-aqueous-type solvent, wherein the positive electrode active material containing nickel in equal to or higher than 50 mole % is used in the metals excluding lithium in the above lithium-containing metal composite oxide, as well as a sulfur-containing cyclic compound having unsaturated bonds in the ring is added in a range of 0.1 to 5 weight % into the above non-aqueous electrolyte.

JP-A-2007-207723 has disclosed a non-aqueous electrolyte secondary battery provided with a positive electrode, a negative electrode and a non-aqueous electrolyte, wherein the aforesaid non-aqueous electrolyte contains at least one kind of unsaturated sultone represented by a predetermined chemical formula, and the positive electrode active material contained in the aforesaid positive electrode is a composite oxide, LiₓMnₐNi_{b}CO_{c}O_{d} (0<x<1.3, a+b+c=1, 1.7≦d≦2.3), having a layer-like α-NaFeO₂-type crystal structure, with |a−b|<0.03 and 0.33≦c<1.

JP-A-2006-344390 has disclosed a non-aqueous electrolyte secondary battery provided with a positive electrode, a negative electrode, a separator and a non-aqueous electrolyte, and a positive electrode potential after charging of equal to or higher than 4.35 V based on Li, wherein the above positive electrode contains a lithium-containing metal composite oxide of a layer structure containing manganese as a constituent element, or a lithium-containing metal composite oxide of a spinel structure containing manganese as a constituent element, as active materials, and the above non-aqueous electrolyte contains a predetermined cyclic sulfuric acid ester derivative or a predetermined cyclic sulfonate ester derivative.

JP-A-2007-128714 has disclosed a positive electrode active material for a non-aqueous electrolyte secondary battery, having a lithium-transition metal composite oxide having at least a layer structure and a spinel structure, wherein the aforesaid lithium-transition metal composite oxide has two or more independent peaks obtained by an X-ray diffraction method between 2θ=18.4 and 19.6 degrees.

### SUMMARY OF THE INVENTION

It is an object of the present invention to suppress the resistance increase in cycles with a wide charge-discharge range, of the lithium ion secondary battery using a positive electrode material by mixing the lithium manganate with the layer-type lithium Mn oxide.

The lithium ion secondary battery of the present invention is the lithium ion secondary battery comprising a positive electrode active material containing manganese spinel and a layer-type lithium manganese oxide, a negative electrode active material, and an electrolyte, characterized in that the aforesaid electrolyte contains vinylene carbonate and unsaturated sultone.

According to the present invention, the lithium ion secondary battery, suppressing the resistance increase in the charge-discharge cycle and having a long life, can be provided.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic cross-sectional view illustrating a lithium ion secondary battery according to the present invention.

FIG. 2 is a graph representing evaluation results of capacity retention rates in a lithium ion secondary battery of an example according to the present invention.

FIG. 3 is a graph representing evaluation results of resistance increasing rates in a lithium ion secondary battery of an example according to the present invention.

FIG. 4 is a graph representing evaluation results of the capacity retention rates of a positive electrode active material in a lithium ion secondary battery of an example according to the present invention.

FIG. 5 is a graph representing evaluation results of the resistance increasing rates of a positive electrode active material in a lithium ion secondary battery of an example according to the present invention.

### DETAILED DESCRIPTION OF THE EMBODIMENTS

The present invention relates to an additive for an electrolyte of the lithium ion secondary battery superior in lifetime characteristics.

In the present invention, in order to apply cheap lithium manganate with high thermal stability as the positive electrode active material of the lithium ion secondary battery, a layer-type lithium Mn oxide is mixed, and still more, VC (vinylene carbonate) and unsaturated sultone are added and mixed to an electrolyte to be used. In this way, the capacity decrease and the resistance increase in the charge-discharge cycle can be suppressed and a longer life as the lithium ion secondary battery can be attained.

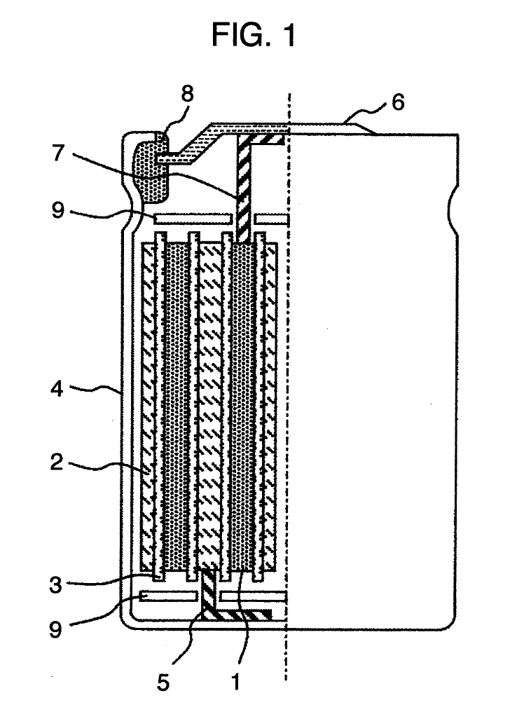

FIG. 1 is a schematic cross-sectional view of a lithium ion secondary battery.

The lithium ion secondary battery (also referred to as the lithium secondary battery) has a configuration where a separator 3 is interposed between a positive electrode plate 1 and a negative electrode plate 2. These positive electrode plate 1, negative electrode plate 2 and separator 3 are wound, and enclosed in a battery can 4 made of stainless steel or aluminum, together with a non-aqueous electrolyte.

A positive electrode lead piece 7 and a negative electrode lead piece 5 are connected to the positive electrode plate 1 and the negative electrode plate 2, respectively, so that electric current is drawn out. Between the positive electrode plate 1 and the negative electrode lead piece 5, and between the negative electrode plate 2 and the positive electrode lead piece 7, an insulating plate 9 is installed, respectively. In addition, between the battery can 4 which is contacted with the negative electrode lead piece 5 and a sealing lid part 6 which is contacted with the positive electrode lead piece 7, a packing 8 is installed for preventing leakage of the electrolyte as well as separating the plus electrode and the minus electrode.

The positive electrode plate 1 is one coated with a positive electrode mixture onto a collector formed by aluminum or the like. The positive electrode mixture contains a positive electrode active material contributing to the storage and discharge of Li, a conducting material and a binder or the like.

The negative electrode plate 2 is one coated with a negative electrode mixture onto a collector formed by copper or the like. The negative electrode mixture contains a negative electrode active material contributing to the storage and discharge of Li, the conducting material and the binder or the like.

As the negative-electrode active material, metallic lithium, a carbon material or a material capable of lithium-intercalation or a lithium compound-formable material may be used, and the carbon material is particularly suitable.

The carbon material include graphite such as natural graphite, artificial graphite; and amorphous carbon such as coal-type cokes, carbide of coal-type pitch, petroleum-type cokes, carbide of petroleum-type pitch, carbide of pitch cokes. Preferably, it is desirable that the above carbon material is subjected to various surface treatments.

These carbon materials may be used alone or may be used in combination with two or more kinds. In addition, the material capable of lithium-intercalation or the lithium compound-formable material includes a metal such as aluminum, tin, silicon, indium, gallium, magnesium, and an alloy containing these elements, a metallic oxide containing tin, silicon. Still more, it includes a composite material of the aforementioned metal or alloy or metal oxide with the carbon material of graphite-type or amorphous carbon.

As one of the active material of the positive electrode plate 1 (positive electrode active material), lithium manganate having a spinel structure (hereinafter may be abbreviated as “manganese spinel”) is used.

As this manganese spinel, specifically, one represented by a general formula LiₐMn_{b}M_{c}O₄ (wherein, a+b+c=3, 0≦a≦1.1, 0<c≦0.07; and M is at least one kind of element selected from a group consisting of Ni, Fe, Zn, Mg and Cu) is used.

The aforesaid manganese spinel is one aiming to suppress deterioration by M substitution, using LiMn₂O₄ as a base material. The total content of Li, Mn and M, a+b+c, is preferably a+b+c=3, to maintain the spinel structure of LiMn₂O₄, as the base material. When a+b+c≠3, the spinel structure tends to be disordered.

The Li content, a, is 1.0≦a≦1.1, and when a<1.0, because other elements occupy Li sites, diffusion of a Li ion is inhibited. In addition, when 1.1<a, the content of the transition metal such as Mn in the positive electrode active material is caused to decrease relative to the content of Li, resulting in decreasing of the capacity of the lithium ion secondary battery. A further preferable range is 1.06≦a≦1.1.

The content of M (at least one kind selected from a group consisting of Ni, Fe, Zn, Mg and Cu), c, is 0<c≦0.07. When c=0, an average valence of Mn becomes below 3.5, which makes the crystal structure unstable and thus promotes deterioration by elution of a large quantity of manganese into the electrolyte by the charge-discharge. On the other hand, when 0.07<c, M is substituted by divalent, which significantly increases the valence of Mn to maintain the electrically neutral condition. Because the charge-discharge of manganese spinel is performed by the valence change of Mn, an increase in the valence of Mn results in decreasing in the capacity of the lithium ion secondary battery. A further preferable range is 0.01≦c≦0.03.

As the active material of another kind of the positive electrode plate 1, Li(COₓNi_{y}Mn_{z})O₂ (wherein x+y+z=1) is used. Hereinafter, this active material is also referred to as a layer-type lithium-manganese composite oxide.

An example of a preparation method for the lithium ion secondary battery is as follows.

The positive electrode active material is mixed together with the conducting material of carbon material powders and a binder such as polyvinylidene fluoride to prepare a slurry. The mixing ratio of the conducting material is desirably 3 to 10 weight %, relative to the positive electrode active material. In addition, the mixing ratio of the binder is desirably 2 to 10 weight % relative to the positive electrode active material. In this case, the mixing ratio of the lithium manganate and the layer-type lithium-manganese composite oxide is desirably about 90:10 to 50:50 in weight ratio. And, it is preferable to perform sufficient kneading using a kneading machine to make dispersion of the positive electrode active material uniform in the slurry.

The resultant slurry is coated on both surfaces of aluminum foil with a thickness of 15 to 25 μm by using, for example, a roll transcriber etc. After coating on both surfaces, an electrode plate of the positive electrode plate 1 is formed by press drying. Thickness of the mixture part, where the positive electrode active material, the conducting material and the binder are mixed, is desirably 200 to 250 μm.

The negative electrode is mixed with the binder and coated similarly as the positive electrode, to form the electrode by press drying. In this case, the thickness of the negative electrode active material is desirably 100 to 150 μm. As the negative electrode plate 2, copper foil with a thickness of 7 to 20 μm is used as the collector. The mixing ratio of the material to be coated is desirably, for example, 90:10 to 98:2, in the weight ratio of the negative electrode active material and the binder.

The resultant electrode plate is cut to a predetermined length to form the electrode, and a tab part of an electric current drawing part is formed by spot welding or ultrasonic wave welding. The tab part is made of the collector with a rectangular shape and metal foil made of the same material, and is to be installed for drawing the electric current from the electrode, and thus becomes the positive electrode lead 7 and the negative electrode lead 5.

Between the positive electrode plate 1 and the negative electrode plate 2 attached with the tab, the separator 3 formed with a microporous film, for example, polyethylene (PE) or polypropylene (PP) etc. is sandwiched and laminated, which is wound cylinder-like to provide an electrode group, which is stored in the battery can 4 of a cylindrical container. Alternately, by using a bag-like one as the separator, the electrodes may be stored therein, so as to be stored in a square-type container by sequentially laminating them. Material of the container is desirably stainless steel or aluminum.

After storing the battery group into the battery can 4, a non-aqueous electrolyte is filled and sealed using the sealing lid part 6 and the packing 8.

As the non-aqueous electrolyte, it is preferable to use one in which a lithium salt such as lithium hexafluorophosphate (LiPF₆), lithium tetrafluoroborate (LiBF₄), lithium perchlorate (LiCLO₄), and lithium bis-oxalatoborate (LiBOB) is dissolved as an electrolyte in a solvent such as ethylene carbonate (EC), propylene carbonate (PC), dimethyl carbonate (DMC), diethyl carbonate (DEC), methyl ethyl carbonate (MEC), methyl acetate (MA), methyl propyl carbonate (MPC), or vinylene carbonate (VC). The concentration of the electrolyte is desirably 0.7 to 1.5 M.

In this way, thus prepared lithium ion secondary battery has a configuration, in which a pair of the positive electrode and the negative electrode opposes via the separator and the non-aqueous electrolyte, and thus the lithium ion secondary battery having a high energy density and superior high-rate-characteristics can be provided.

Explanation will be given below on Examples of the present invention. It goes without saying that the present invention should not be limited to these examples.

### Example 1

One example of a preparation method for the lithium ion secondary battery in the present example is as follows.

Explanation will be given on production of a 18650-type (diameter of 18 mm×height of 650 mm) battery.

Firstly, a positive electrode active material, a conductive material of a carbon material powder, and a poly (vinilidene fluoride) (PVdF) binder were mixed so as to be 90:4.5:5.5 in weight ratio, and a suitable amount of 1-methyl-2-pyrolidone (NMP) was added to produce a slurry. As the positive electrode active material in this case, one mixed with the lithium manganate (manganese spinel) and the layer-type lithium-manganese composite oxide by equal amount in weight ratio was used. The slurry prepared was kneaded by stirring for 3 hours with a planetary mixer.

Then, the slurry kneaded was coated on both surfaces of an aluminum foil with a thickness of 20 μm by using a coater of a roll transcriber. This was pressed with the roll press machine so as to attain a mixture density of 2.65 g/cm³ to obtain the positive electrode.

Using amorphous carbon as the negative electrode active material, carbon black as the collector, and the PVdF as the binder, they were mixed so as to be 92.2:1.6:6.2 in weight ratio to perform kneading by stirring for 30 minutes with a slurry mixer.

The slurry kneaded was coated on both surfaces of a copper foil with a thickness of 10 μm by using a coating machine, and after drying, it was pressed with the roll press to obtain the negative electrode.

The electrode for the positive electrode and the electrode for the negative electrode were each cut to a predetermined size, and an electric current collecting tab was installed by ultrasonic wave welding at a part not coated with the slurry (an uncoated part) in these electrodes.

After sandwiching a porous polyethylene film between the electrodes of the positive electrode and the negative electrode, and winding cylindrically, it was inserted into the 18650-type battery can.

After connecting the electric current collecting tab and a lid of the battery can, the lid part of the battery can and the battery can were welded by laser welding to seal the battery.

Finally, a non-aqueous electrolyte was charged from a liquid filling port installed at the battery can to obtain the 18650-type battery. It should be noted that the battery weight was 38 g.

The electrolyte used was obtained by dissolving a 1.0 mole of LiPF₆ in a mixed solvent of EC (ethylene carbonate) and EMC (ethyl methyl carbonate), and adding thereto VC (vinylene carbonate) and 1,3-prop-1-ene sultone (chemical formula: C₃H₄O₃S) being an unsaturated sultone so that each becomes 1 weight % relative to the total weight of the electrolyte after mixing.

Explanation will be given below on evaluation of the cycle characteristics of the battery.

The battery prepared was transferred to a constant temperature chamber held at 25° C. and held for 1 hour. Initial charge-discharge was performed by charging up to 4.2 V at an electric current of 0.3 A under the constant electric current/constant voltage condition, and after that by discharging down to 2.7 V under an electric current of 0.3 A. Then a cycle of charging up to 4.2 V at an electric current of 1 A under the constant electric current/constant voltage condition and then discharging down to 2.7 V at an electric current of 1 A, was repeated for 3 cycles. In this way, a discharge capacity after the 3 cycles was evaluated as an initial discharge capacity of the present invention.

After that, the battery was transferred to a constant temperature chamber held at 45° C., and a cycle of charging up to 4.2 V at a constant electric current of 0.5 A and then discharging down to 3 V at an electric current of 0.5 A, was repeated for 200 cycles. After completion of 200 cycles, the battery was transferred to a constant temperature chamber held at 25° C., and held for 3 hours till the battery temperature became 25° C. After that, a cycle of charging up to 4.2 V at an electric current of 1 A under the constant electric current/constant voltage condition and then discharging down to 2.7 V at an electric current of 1 A, was repeated for 3 cycles, and discharge capacity at 3th cycle was evaluated as a capacity after the cycle. Then the battery was transferred to a constant temperature chamber held at 45° C., and a charge-discharge cycle at 0.5 A was continued. The cycle evaluation was performed till the integrated number of the cycles reached 1000.

### Example 2

Example 2 was performed under the same condition as in Example 1, except that the VC and the 1,3-prop-1-ene sultone were added so as to make each 1.5 weight % relative to the total weight of the electrolyte after mixing.

### Example 3

Example 3 was performed under the same condition as in Example 1, except that the VC and the 1,3-prop-1-ene sultone were added to the electrolyte so as to make each 0.5 weight % relative to total weight of the electrolyte after mixing.

### Comparative Example 1

Comparative Example 1 was performed under the same condition as in Example 1, except that the VC was added to the electrolyte so as to make 1.0 weight % relative to the total weight of the electrolyte after mixing.

### Comparative Example 2

Comparative Example 2 was performed in accordance with Example 1 except that the lithium manganate (manganese spinel) was used alone as the positive electrode active material.

### “Evaluation Method for Direct Current Resistance”

Explanation will be shown below on an evaluation method for the resistance of the 18650-type battery prepared and evaluated in the present invention. As for resistance, direct current resistance was measured from the slope of an electric current-voltage plot.

After the evaluation of the initial capacity described in Example 1, the battery was charged up to 4.2 V at an electric current of 0.5 A under the constant electric current/constant voltage condition. After halting for 30 minutes, discharging was performed at an electric current of 0.5 A for 11 seconds. Further, after halting for 30 minutes, discharging was performed at an electric current of 1 A for 11 seconds, and after halting for 30 minutes, discharging was performed under an electric current of 2 A for 11 seconds.

Then, differences between an open circuit voltage (OCV) just before performing the discharge at each electric current (0, 5 A, 1 A, 2 A) were determined, and current values evaluated were plotted in the X-axis, and voltage differences (OCV—voltage at 10 second) in the Y-axis, to calculate the direct current resistance value from the slope, and this value was used as an initial resistance.

Then, after a capacity confirmation test at every 200 cycles, the direct current resistance was evaluated by a similar procedure and a change from the initial value was defined as a resistance increasing rate.

### “Evaluation Results of Capacity Retention Rates”

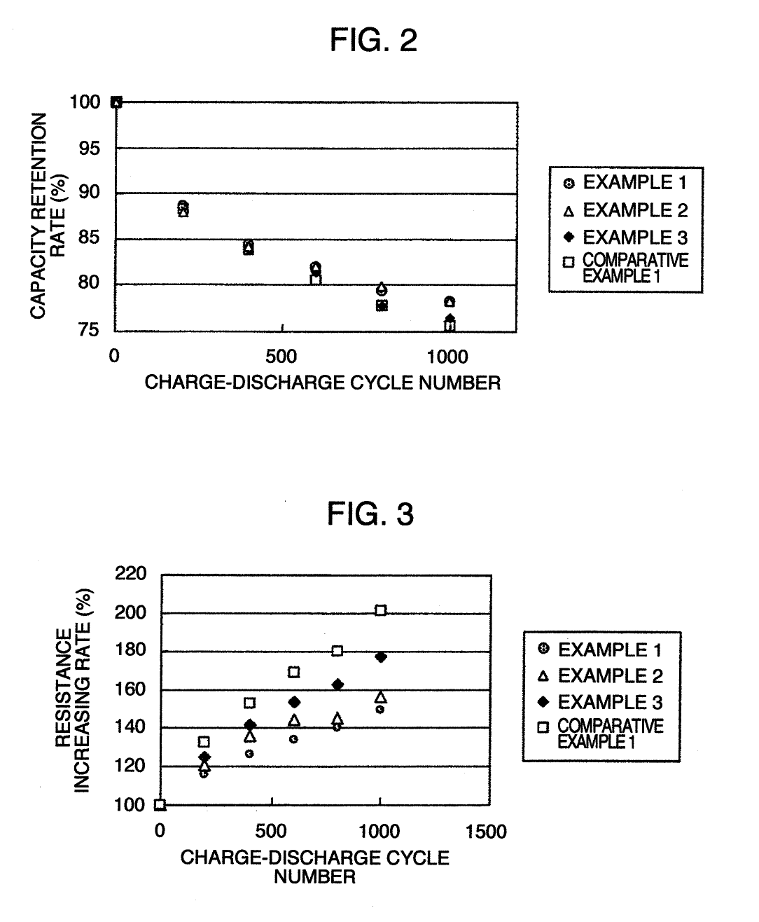

Evaluation results for Examples 1 to 3, and Comparative Example 1 are represented in FIG. 2.

It is understood from this drawing that in the batteries of Examples 1 to 3 in which the VC and the 1,3-prop-1-ene sultone were added to the electrolyte, the decrease in the capacity is suppressed as compared with Comparative Example 1 in which only the VC was added. And, it is understood that, in the batteries of Examples 1 to 3, the more the added amount of VC and unsaturated sultone is, the more the suppression of the capacity decrease is.

### “Evaluation Results of Resistance Increasing Rates”

Evaluation results for Examples 1 to 3, and Comparative Example 1 are represented in FIG. 3.

It is understood from this drawing that in the batteries of Examples 1 to 3 in which the VC and the 1,3-prop-1-ene sultone were added to the electrolyte, increase in the resistance is suppressed as compared with Comparative Example 1 in which only the VC was added. In addition, it is understood that, in the batteries of Examples 1 to 3, the added amount of the VC and the unsaturated sultone of each 1 weight % provides the most suppression of the resistance increase.

Explanation will be given here on actions, when the VC and the unsaturated sultone were applied to the electrolyte of the battery.

It is considered that the VC is positively (plus) charged by the breaks of the double bonds present in the molecule by electrochemical action, and forms a protection film by being adsorbed onto the surface of the negative electrode.

In addition, the unsaturated sultone has a bonding between sulfur (S) and oxygen (O) in the molecule, being polarized, and it is considered that because oxygen at the terminal part is negatively (minus) charged, it forms a protection film by being adsorbed onto the surface of the positive electrode.

It is considered that the increase in resistance is suppressed by these actions.

In Comparative Example 1, it is considered that, because the electrolyte contains only the VC and does not contain the unsaturated sultone, protection of the positive electrode is not sufficient, and the resistance increases as compared with Examples 1 to 3.

### “Evaluation Results of the Capacity Retention Rate of the Positive Electrode Active Material”

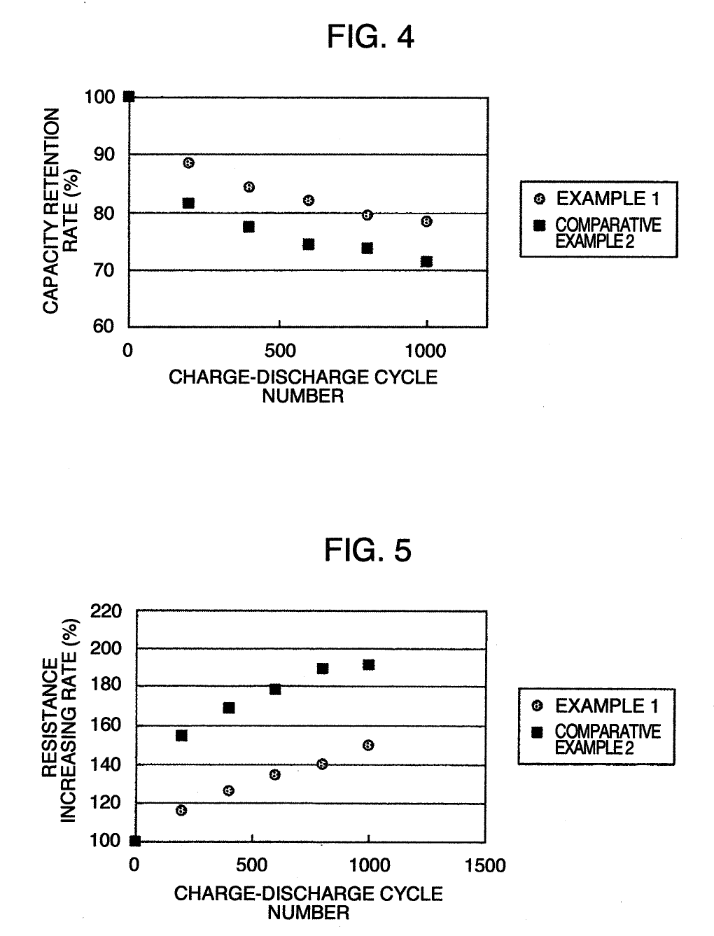

Evaluation results of Example 1 and Comparative Example 2 are represented in FIG. 4.

It is understood from this drawing that, when the lithium manganate (manganese spinel) was used alone as the positive electrode active material, even if the VC and the 1,3-prop-1-ene sultone were added to the electrolyte, decrease in the capacity from the initial to the 200th cycle is large. Therefore, it was confirmed that the effect of the present invention is clearer when the positive electrode active material is a mixture of the lithium manganate (manganese spinel) and the layer-type lithium manganese oxide.

### “Evaluation Results of the Increase in the Resistance of the Positive Electrode Active Material”

Evaluation results of Example 1 and Comparative Example 2 are represented in FIG. 5.

It is understood from this drawing that, similarly to the evaluation results of the capacity retention rate, when the lithium manganate (manganese spinel) was used alone as the positive electrode active material, even if the VC and the 1,3-prop-1-ene sultone were added to the electrolyte, increase in the resistance from the initial to the 200th cycle is large. Therefore, it was confirmed that the effect of the present invention is clearer when the positive electrode active material is a mixture of the lithium manganate (manganese spinel) and the layer-type lithium manganese oxide.

According to the present invention, in applying the materials, in which the layer-type lithium Mn oxide is mixed to the lithium manganate (manganese spinel), to the positive electrode material of the lithium ion secondary battery, the capacity decrease or the resistance increase is suppressed by adding the VC and the unsaturated sultone at the same time to the electrolyte, and so the lithium ion secondary battery which is cheap and thermally stable even in abuse can be provided.

The positive electrode active material obtained in the present invention is thermally stable, as compared with conventionally used lithium cobaltate (LiCoO₂) or the like, so that applications thereof are expected to mobile objects requiring a large-scale lithium ion secondary battery having excellent safety, or power sources for stationary-type power storage systems.

1. A lithium ion secondary battery comprising a positive electrode plate containing a positive electrode active material, a negative electrode plate containing a negative electrode active material, a separator, an electrolyte, and a battery can for enclosing these, wherein said positive electrode active material comprises manganese spinel and a layer-like-type lithium manganese oxide, and said electrolyte comprises vinylene carbonate and unsaturated sultone.

2. The lithium ion secondary battery according to claim 1, wherein said layer-type lithium manganese oxide is Li(COₓNi_{y}Mn_{z})O₂ (wherein x+y+z=1).

3. The lithium ion secondary battery according to claim 1, wherein said manganese spinel is LiₐMn_{b}M_{c}O₄ (wherein a+b+c=3, and M is at least one kind of an element selected from a group consisting of Ni, Fe, Zn, Mg and Cu).

4. The lithium ion secondary battery according to claim 2, wherein said manganese spinel is LiₐMn_{b}M_{c}O₄ (wherein a+b+c=3, and M is at least one kind of an element selected from a group consisting of Ni, Fe, Zn, Mg and Cu).
